(19) United States
(12) Patent Application Publication
(10) Pub. No.: US 2025/0168539 A1
(43) Pub. Date: May 22, 2025

(54) OPTICAL PATH CONTROL DEVICE, OPTICAL PATH CONTROL METHOD, AND PROGRAM

(71) Applicant: Nippon Telegraph and Telephone Corporation, Tokyo (JP)

(72) Inventors: Minoru Sakuma, Musashino-shi, Tokyo (JP); Kazuki SHIMADA, Musashino-shi, Tokyo (JP)

(21) Appl. No.: 18/836,269

(22) PCT Filed: Feb. 17, 2022
(86) PCT No.: PCT/JP2022/006365

§ 371 Date: Aug. 6, 2024

(51) Int. Cl. H04Q 11/00; H04B 10/2575; H04L 67/02

(52) U.S. Cl. CPC H04Q 11/0062; H04B 10/2575; H04L 67/02; H04Q 2011/0073

(57) ABSTRACT

An optical path control device 1 includes: a conversion unit 323 configured to convert a connection source user ID and a connection destination user ID included in a connection request for an optical path, which is transmitted from a service provision device 2, into two optical path endpoints of the optical path; and a generation unit 324 configured to generate control information for a transmission device 5 arranged in a carrier network using transmission system parameters of the optical path corresponding to the two optical path endpoints.

### TECHNICAL FIELD

The present invention relates to an optical path control device, an optical path control method and a program.

### BACKGROUND ART

Optical path control has been performed as static path opening by a communication carrier operator. In the future, it is expected that there will be an increase in the number of cases where third-party service companies dynamically connect optical paths on demand, such as for sports broadcasting.

Telephony Application Programming Interface (TAPI) is known as a technology for controlling a transmission device and implementing a network connection including optical paths using an API (Non Patent Literature 1).

### CITATION LIST

### Non Patent Literature

[NPL 1] Karthik Sethuraman, Andrea Mazzini, Stephane St Laurent, Lyndon Ong, “ONF Transport API Opening up Disaggregated Optical Transport Applications”, Dec. 3, 2018, online, Internet <URL: https://opennetworking.org/wp-content/uploads/2018/12/TAPI-Intro-Concepts-ODTN.pdf>

### SUMMARY OF INVENTION

### Technical Problem

TAPI is a technology for aiming at network maintenance personnel with knowledge of networks, and is a specification for dealing with parameters relating to a transmission technology such as optical frequencies. Therefore, it is difficult for general users who have no knowledge of transmission system networks to control optical paths using TAPI.

The present invention has been made to address the problems above, and an object of the present invention is to provide a technology that allows even a user who has no knowledge of transmission system networks to control optical paths.

### Solution to Problem

In order to achieve the object above, one aspect of the present invention is an optical path control device including: a conversion unit configured to convert a connection source user ID and a connection destination user ID included in a connection request for an optical path, which is transmitted from a service provision device, into two optical path endpoints of the optical path; and a generation unit configured to generate control information for a transmission device arranged in a carrier network using transmission system parameters of the optical path corresponding to the two optical path endpoints.

One aspect of the present invention is an optical path control method executed by an optical path control device, the method including: a conversion step of converting a connection source user ID and a connection destination user ID included in a connection request for an optical path, which is transmitted from a service provision device, into two optical path endpoints of the optical path; and a generation step of generating control information for a transmission device arranged in a carrier network using transmission system parameters of the optical path corresponding to the two optical path endpoints.

One aspect of the present invention is a program which causes a computer to function as the optical path control device.

### Advantageous Effects of Invention

According to the present invention, it is possible to allow even a user who has no knowledge of transmission system to control optical paths.

### BRIEF DESCRIPTION OF DRAWINGS

FIG. 1 is a diagram illustrating a configuration example of a network system according to the present embodiment.

FIG. 2 is a diagram illustrating a configuration example of an optical path control device.

FIG. 3 is a diagram illustrating examples of a user information database and a topology database.

FIG. 4 is a sequence diagram illustrating operations of the network system.

FIG. 5 is an example of a hardware configuration.

### DESCRIPTION OF EMBODIMENTS

An embodiment of the present invention will be described below with reference to the drawings.

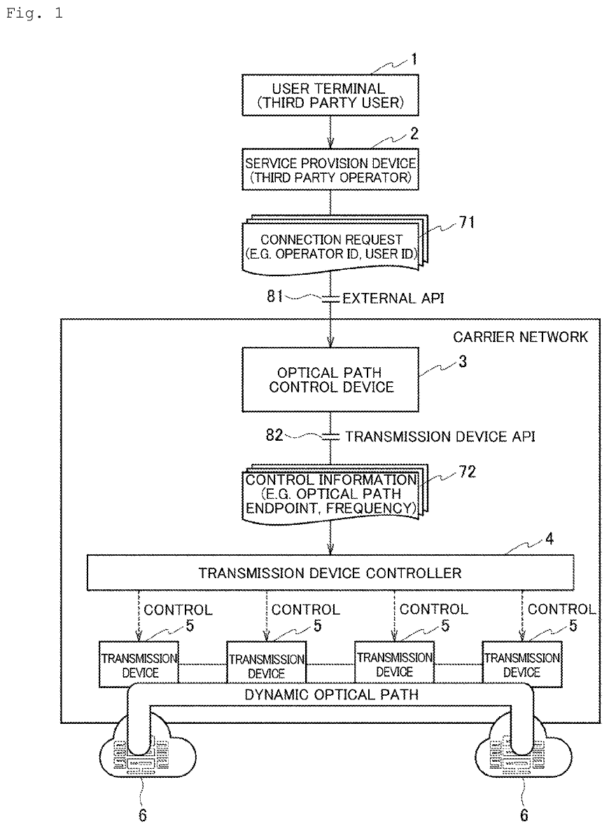

FIG. 1 is a diagram illustrating a configuration example of a network system according to the present embodiment. The illustrated network system includes a user terminal 1 and a service provision device 2, which are located outside a carrier network. The network system also includes an optical path control device 3, a transmission device controller 4, and a transmission device 5, which are arranged in the carrier network. The network system includes an optical endpoint 6. Specifically, the optical endpoint 6 is an optical terminal having an optical path interface, and is placed at a base such as a building or a user's home.

The user terminal 1 is a terminal used by a user (third party user) who uses a service provided by the service provision device 2.

The service provision device 2 is a device that provides various application services. Application services include, for example, online distribution of various events such as sports and games, and hybrid distribution in which events are held online and offline simultaneously. The service provision device 2 is a device managed and operated by a service provider that provides application services. The service provision device 2 receives a request from the user terminal 1 and transmits a connection request 71 for a dynamic optical path to the optical path control device 3 of the carrier network.

It is assumed that the service provider in the present embodiment is a third party operator other than a carrier (communications carrier) that provides the carrier network. However, the service provider may be a carrier that provides the carrier network.

The optical path control device 3 converts the optical path connection request 71 transmitted from the service provision device 2 into control information 72 for the transmission device 5 and transmits it to the transmission device controller 4.

The transmission device controller 4 controls the transmission device 5 using the control information 72 transmitted from the optical path control device 3, and controls the connection of dynamic optical path. The transmission device 5 dynamically sets an optical path under the control of the transmission device controller 4.

The network system of the present embodiment has an external API 81 and a transmission device API 82. The external API 81 is arranged between the service provision device 2 and the optical path control device 3, and is an API (first API) directed to the service provision device 2 outside the carrier network. The transmission device API 82 is arranged between the optical path control device 3 and the transmission device controller 4, and is an API (second API) directed to the transmission device 5.

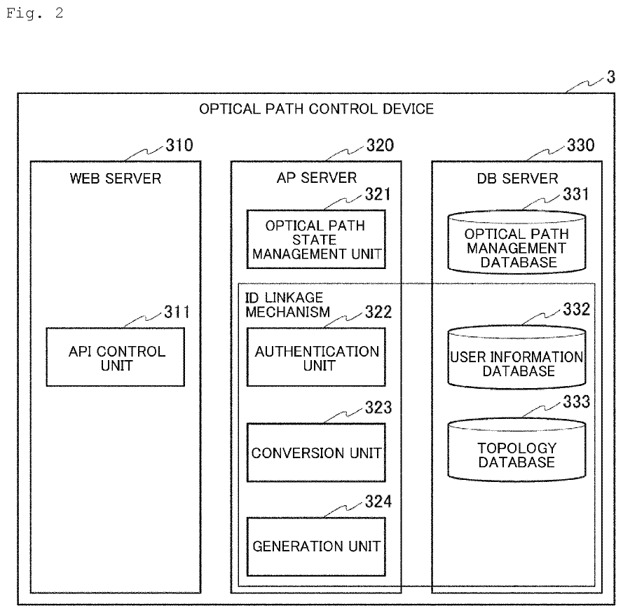

FIG. 2 is a diagram illustrating a configuration example of the optical path control device 3. The optical path control device 3 includes an API control unit 311, an optical path state management unit 321, an authentication unit 322, a conversion unit 323, a generation unit 324, an optical path management database 331, a user information database 332, and a topology database 333.

The optical path control device 3 may have a configuration based on a three-layered web model as illustrated in the drawings. That is, the optical path control device 3 may include a web server 310 (web layer), an AP (application) server 320 (AP layer), and a database server 330 (DB layer). In this case, the API control unit 311 is arranged in the web server 310; the optical path state management unit 321, the authentication unit 322, the conversion unit 323, and the generation unit 324 are arranged in the AP server 320; and the optical path management database 331, the user information database 332, and the topology database 333 are arranged in the DB server 330.

The authentication unit 322, the conversion unit 323, the generation unit 324, the user information DB 332, and the topology database 333 function as an ID linkage mechanism for linking various IDs of the optical path connection request 71 transmitted from the outside with the transmission system parameters of the optical path.

The API control unit 311 controls the API 81 (web-API) directed to the outside of the carrier network and the API 82 directed to the transmission device 5. In particular, the API control unit 311 activates the external API 81, which is an interface for the external service provision device 2 to set up the optical path in the carrier network. The API control unit 311 also activates the API 82, which is an interface to the transmission device controller 4 in the carrier network. That is, the API control unit 311 sets the control information generated by the generation unit 324 as the transmission system parameters for the transmission device controller 4 and activates the API 82. This allows the user or the service provider to easily control the dynamic optical path.

The optical path state management unit 321 monitors and acquires a connection state of the set dynamic optical path, and stores the acquired connection state of the dynamic optical path in the optical path management database 331.

The authentication unit 322 uses the user information database 332 to authenticate an operator ID of the service provision device 2 and a user ID of the user terminal 1.

The conversion unit 323 converts a connection source user ID and a connection destination user ID included in the optical path connection request 71 transmitted from the service provision device 2 into two optical path endpoints of the optical path. Specifically, the conversion unit 323 may refer to the user information database 332 in which user information is stored, and may convert each of the connection source user ID and connection destination user ID into two optical path endpoints. The conversion unit 323 receives the connection request 71 transmitted from the service provision device 2 via the API control unit 311.

The generation unit 324 generates the control information 72 for the transmission device 5 arranged in the carrier network using the transmission system parameters of the optical path corresponding to the two optical path endpoints converted by the conversion unit 323. Specifically, the generation unit 324 may refer to the topology database 333 that stores transmission system parameters of the optical path, identifies the transmission system parameters of the optical path corresponding to the two optical path endpoints, and generate the control information 72 using the transmission system parameters and the two optical path endpoints. In this way, the generation unit 324 converts the connection request 71 (service requirements) transmitted from the service provision device 2 into parameters for the transmission device 5. The generation unit 324 transmits the control information 72 to the transmission device controller 4 via the API control unit 311.

The optical path management database 331 stores the connection state (for example, whether it is connecting or connected) of each optical path that is dynamically connected. When the optical path is connected, the optical path state management unit 321 registers information of the optical path in the optical path management database 331, and when the optical path connection is terminated, the optical path state management unit 321 deletes the information of the optical path from the optical path management database 331. Therefore, the optical path management database 331 stores only information about optical paths that are dynamically connected, and does not store information about optical paths that are not connected.

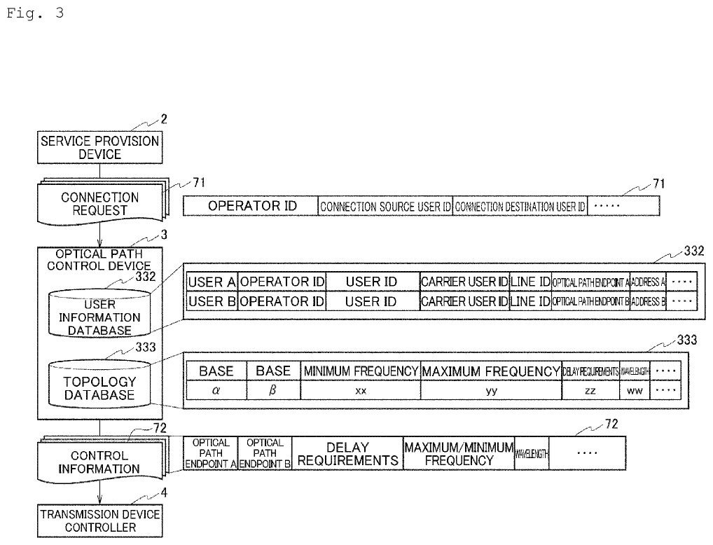

The user information database 332 and the topology database 333 will be explained referring to FIG. 3.

The user information database 332 stores information on each user who uses the user terminal 1. The user information database 332 illustrated in FIG. 3 stores, for each user, a user name, an operator ID, a user ID (off-network user ID), a carrier user ID (on-network user ID), a line ID, an optical path endpoint, and an address. The operator ID is an operator ID of the service provider (third party operator) of the service used by the user. The user ID is an off-network user ID assigned to the user by the service provider. The carrier user ID is an in-network user ID assigned to the user by the carrier. The optical path endpoint is an optical terminal at the end of the optical path.

The topology database 333 stores a configuration of the optical path of the carrier network. The topology database 333 illustrated in FIG. 3 stores transmission system parameters (topology information) relating to each optical path (communication route) between two bases. Specifically, the topology DB 333 stores, for each optical path, transmission system parameters relating to the optical path, such as the two bases that are starting and ending points of the optical path, the minimum usable frequency, the maximum usable frequency, delay requirements and wavelength. The base is assumed to be, for example, a building or a user's home. Therefore, at least one optical path endpoint exists at one base.

Specific processing by the conversion unit 323 and the generation unit 324 will be described with reference to FIG. 3.

In the example illustrated in FIG. 3, the service provision device 2 transmits the connection request 71 including service requirements such as an operator ID, a connection source user ID and a connection destination user ID to the optical path control device 3 via the external API 81.

The conversion unit 323 uses the user information database 332 to obtain a source optical path endpoint and destination optical path endpoint from the operator ID, the connection source user ID, and the connection destination user ID of the connection request 71. That is, the conversion unit 323 extracts a record (user A's record) having the operator ID and the connection source user ID of the connection request 71 from the user information database 323, and identifies an optical path endpoint A. Further, the conversion unit 323 extracts a record (user B's record) having the operator ID and the connection destination user ID of the connection request 71 from the user information database 323, and identifies an optical path endpoint B. In this way, the conversion unit 323 converts endpoints known to the user (the connection source user ID and the connection destination user ID) into endpoints of the optical path (optical path endpoint A and optical path endpoint B).

Then, the conversion unit 323 converts each optical path endpoint into a base. Specifically, the conversion unit 323 refers to the user information database 323 and uses the user's address set in the extracted record to acquire a base corresponding to the address (for example, a building or a user's home corresponding to the address). In the example illustrated in FIG. 3, the conversion unit 323 identifies a base a corresponding to an address in the user A's record, and a base B corresponding to an address in the user B's record.

The generation unit 324 extracts a record in which the identified bases (base a and base B) are endpoints of the optical path from the topology database 333, and generates the control information 72 including the transmission system parameters set in the record and the optical path endpoints specified by the conversion unit 323. The illustrated control information 72 includes, for example, delay requirements, maximum frequency, minimum frequency, and wavelength as the transmission system parameters.

Accordingly, the conversion unit 323 and the generation unit 324 of the present embodiment appropriately convert or complement parameters included in the connection request 71 for the operator or the user into transmission system parameters for a transmission device, thereby implementing parameter interworking.

Specifically, the conversion unit 323 converts the connection source user ID and the connection destination user ID included in the optical path connection request 71 transmitted from the service provision device 2 outside the carrier network into two optical path endpoints, thereby allowing external users such as users and operators to easily control the optical path.

Further, the generation unit 324 can set transmission system parameters in consideration of topology information. That is, the generation unit 324 can set transmission system parameters such as frequency and wavelength in consideration of a state of the dynamic optical path between respective bases.

The conversion unit 323 may convert the connection source user ID (off-network user ID) of the connection request 71 into the carrier user ID (off-network user ID) using the user information database 332. Therefore, a customer system (not illustrated) can perform processing such as billing to a user using the carrier user ID.

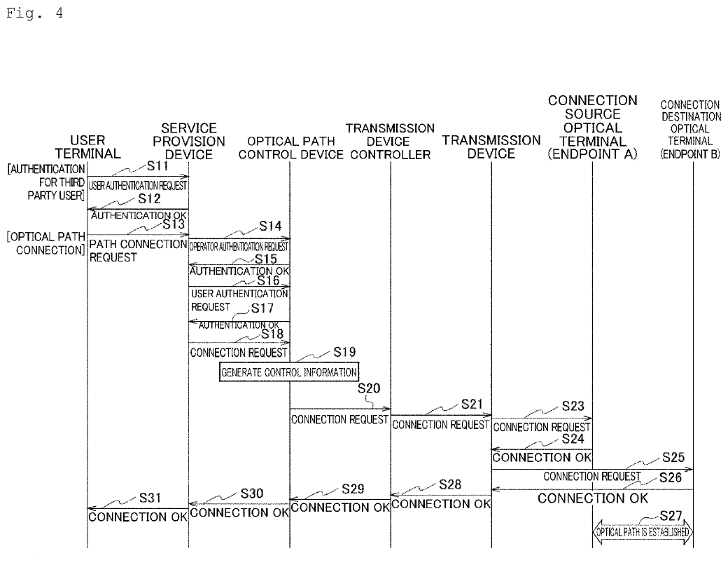

FIG. 4 is a sequence diagram illustrating operations of the network system of the present embodiment.

The user terminal 1 transmits an authentication request including the user ID (off-network user ID) of the user using the user terminal 1 to the service provision device 2 (step S11). The service provision device 2 authenticates whether the user ID included in the authentication request is a valid user ID using an authentication database (not illustrated), and transmits the authentication result to the user terminal 1 (step S12). The service provision device 2 transmits the authentication result indicating that the authentication has succeeded to the user terminal 1.

When the authentication has succeeded, the user terminal 1 transmits a dynamic optical path connection request to the service provision device 2 (step S13). The connection request includes the user ID (off-network user ID) in step S11 as the connection source user ID. If the user knows the connection destination user ID, the connection source user ID and the connection destination user ID may be included in the connection request.

When receiving the connection request from the user terminal 1, the service provision device 2 transmits an authentication request for the operator ID to the optical path control device 3 (step S14). The operator ID is an operator ID of a service provider who operates and manages the service provision device 2, and is held in a storage unit of the service provision device 2. When receiving the authentication request, the optical path control device 3 refers to the user information database 332, authenticates the operator ID, and transmits the authentication result to the service provision device 2 (step S15). For example, if the operator ID exists in the user information database 332, the optical path control device 3 determines that this operator is legitimate, and transmits the authentication result indicating that the authentication has succeeded to the service provision device 2.

The service provision device 2 transmits a user authentication request including the connection source user ID and the operator ID included in the connection request in step S13 to the optical path control device 3 (step S16). When receiving the user authentication request, the optical path control device 3 refers to the user information database 332, authenticates the connection source user ID and the operator ID, and transmits the authentication result to the service provision device 2 (step S17). Specifically, if a record including the connection source user ID and the operator ID exists in the user information database 332, the optical path control device 3 determines that the connection source user ID is a legitimate user ID, and transmits the authentication result indicating that the authentication has succeeded to the service provision device 2.

When the authentication has succeeded, the service provision device 2 transmits the dynamic optical path connection request 71 to the optical path control device 3 via the external API 82 (step S18). This connection request 71 includes the operator ID, the connection source user ID, and the connection destination user ID. In a case where the connection destination user ID is included in the connection request in step S13, the service provision device 2 generates the connection request 71 by adding the operator ID to the connection request in step S13. On the other hand, in a case where the connection destination user ID is not included in the connection request in step S13, the service provision device 2 identifies the connection destination user ID corresponding to the connection source user ID, and generates the connection request 71 including the connection destination user ID, the connection source user ID and the operator ID. It is assumed that the service provision device 2 holds a table in which connection source user IDs and connection destination user IDs are associated with each other.

The optical path control device 3 receives the dynamic optical path connection request 71 from the service provision device 2, and generates the control information 72 for controlling the transmission device 5 based on the connection request 71 (step S19). The generation of the control information 72 is as described with reference to FIG. 3.

The optical path control device 3 transmits the dynamic optical path connection request including the control information 72 to the transmission device controller 4 via the transmission device API 82 (step S20). The transmission device controller 4 receives the connection request and transmits the connection request to each of the transmission devices 5 corresponding to the optical path endpoints set in the control information (step S21). Each transmission device 5 transmits the dynamic optical path connection request to optical path endpoints 6 (source optical terminal and destination optical terminal) set in the control information of the connection request (steps S23 and S25).

Each optical path endpoint 6 (source optical terminal and destination optical terminal) transmits a connection OK response indicating that the connection has succeeded to the corresponding transmission device 5 (steps S24 and S26). Accordingly, the dynamic optical path is established between the source optical terminal and the destination optical terminal (step S27).

When receiving the connection OK response from each optical path endpoint 6, the transmission device 5 transmits the connection OK response to the transmission device controller 4 (step S28). The transmission device controller 4 transmits the connection OK response to the optical path control device 3 (step S29), and the optical path control device 3 transmits the connection OK response to the service provision device 2 (step S30), and the service provision device 2 transmits the connection OK response to the user terminal 1 (step S31).

As described above, the optical path control device 3 of the present embodiment includes: the conversion unit 323 that converts a connection source user ID and a connection destination user ID included in the connection request 71 for an optical path, which is transmitted from the service provision device 2, into two optical path endpoints of the optical path; and the generation unit 324 that generates the control information 72 for the transmission device 5 arranged in a carrier network using transmission system parameters of the optical path corresponding to the two optical path endpoints.

The conversion unit 323 refers to the user information storage database 332 in which user information is stored, and converts each of the connection source user ID and the connection destination user ID into the two optical path endpoints. The generation unit 324 refers to the topology database 333 that stores transmission system parameters of the optical path, identifies transmission system parameters of the optical path corresponding to the two optical path endpoints, and generates the control information 72 using the transmission system parameters and the two optical path endpoints.

Accordingly, it is possible to allow even a user who has no knowledge of transmission system networks to enable dynamic control of optical paths in the present embodiment. Specifically, the present embodiment provides an easy-to-use interface for end users and third party operators who have no network knowledge regarding optical paths, and allows them to easily open dynamic optical paths.

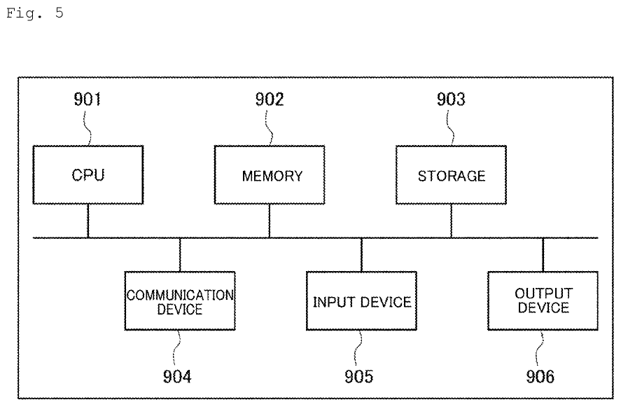

As the optical path control device 3 described above, for example, a general-purpose computer system as illustrated in FIG. 5 can be used. The illustrated computer system includes a central processing unit (CPU, processor) 901, a memory 902, a storage 903 (hard disk drive (HDD) or solid state drive (SSD)), a communication device 904, an input device 905, and an output device 906. The memory 902 and the storage 903 are storage devices. In the computer system, each function of the optical path control device 3 is implemented by the CPU 901 executing the program for the optical path control device 3 loaded into the memory 902.

Further, the optical path control device 3 may be implemented by a single computer or by a plurality of computers. Further, the optical path control device 3 may be a virtual machine implemented on a computer. The program for the optical path control device 3 can be stored in a computer-readable recording medium such as an HDD, an SSD, a USB (universal serial bus) memory, a CD (compact disc), and a DVD (digital versatile disc), or delivered over a network.

The present invention is not limited to the above embodiment, and numerous modifications can be made within the scope and gist of the invention.

### Reference Signs List

1: User terminal
2: Service provision device
3: Optical path control device
311: API control unit
321: Optical path state management unit
322: Authentication unit
323: Conversion unit
324: Generation unit
331: Optical path management database
332: User information database
333: Topology database
4: Transmission device controller
5: Transmission device
6: Optical path endpoint (optical terminal)

1. An optical path control device, comprising:
a conversion unit configured to convert a connection source user ID and a connection destination user ID included in a connection request for an optical path, which is transmitted from a service provision device, into two optical path endpoints of the optical path; and
a generation unit configured to generate control information for a transmission device arranged in a carrier network using transmission system parameters of the optical path corresponding to the two optical path endpoints.

2. The optical path control device according to claim 1, wherein the conversion unit is configured to refer to a user information storage unit in which user information is stored, and convert each of the connection source user ID and the connection destination user ID into the two optical path endpoints, and
the generation unit is configured to refer to a topology storage unit that stores transmission system parameters of the optical path, identifies transmission system parameters of the optical path corresponding to the two optical path endpoints, and generate the control information using the transmission system parameters and the two optical path endpoints.

3. The optical path control device according to claim 2, further comprising:
an API control unit configured to control a first API directed to an outside of the carrier network and a second API directed to the transmission device, wherein
the conversion unit is configured to receive the connection request transmitted from the service provision device via the API control unit, and
the generation unit is configured to transmit the control information to a transmission device controller that controls the transmission device via the API control unit.

4. The optical path control device according to claim 3, wherein
the API control unit is arranged in a web layer,
the conversion unit and the generation unit are arranged in an application layer, and
the user information storage unit and the topology storage unit are arranged in a DB layer.

5. An optical path control method executed by an optical path control device, the method comprising:
converting a connection source user ID and a connection destination user ID included in a connection request for an optical path, which is transmitted from a service provision device, into two optical path endpoints of the optical path; and
generating control information for a transmission device arranged in a carrier network using transmission system parameters of the optical path corresponding to the two optical path endpoints.

6. A computer-readable storage medium storing a program which causes a computer to function as the optical path control device according to claim 1.
